(19) United States
(12) Patent Application Publication
(10) Pub. No.: US 2013/0300662 A1
(43) Pub. Date: Nov. 14, 2013

(54) CONTROL SYSTEM WITH GESTURE-BASED INPUT METHOD

(71) Applicant: HUNG-TA LIU, HSINCHU (TW)

(72) Inventor: HUNG-TA LIU, HSINCHU (TW)

(21) Appl. No.: 13/839,582

(22) Filed: Mar. 15, 2013

(30) Foreign Application Priority Data
May 9, 2012 (TW) 101116508

(51) Int. Cl. G06F 3/01

(52) U.S. Cl. CPC G06F 3/017
USPC 345/158

(57) ABSTRACT

A control system with a gesture-based input method is introduced. The system includes an image capturing unit, an image processing unit, a database, and a computing unit. The image capturing unit captures an input image with a user's gesture. The gesture may be sign-language gesture or gesture of the user holding an object. The image processing unit, connected to the image capturing unit, is used to receive and recognize the gesture shown in the input image. The database stores a plurality of reference images and each of which indicates at least one control command. The computing unit, connected to the image processing unit and database, is used to compare the gesture recognized by the image processing unit with the reference images in the database. The comparison is used to determine a control command corresponding to the reference image. The control command is used to operate an electronic device.

### BACKGROUND

1. Technical Field

The present invention is related to a control system, in particular to the system adopting a gesture-based input method by performing gestures.

2. Description of Related Art

With advancement of the scientific technology, electronic devices have been developed for humans to have more conveniences. It is important when the developers attempt to find out a user-friendly way to advance operations of the electronic devices. For example, people need a period of time to learn how to use the devices correctly such as a computer mouse, keyboard, and remote control which are particularly used to operate the computer or television. It may exist a threshold for the users who are not familiar with the operations of the input devices. More, the described input devices may occupy a certain space, therefore the users may consider how to make room to store up the devices even the remote control. In addition, the computer mouse or keyboard may cause the users to be unhealthy when they feel fatigued and ache while using the devices for a long time.

### SUMMARY

Provided in accordance with the present invention is to a control system with a gesture-based input method. In one of the embodiments of the invention, the control system includes an image capturing unit, an image processing unit, a database, and a computing unit. The image capturing unit is used to capture an input image including an auxiliary object and a user's gesture. The image processing unit, connected to the image capturing unit, is used to receive and recognize the gesture in the input image. The gesture may be a sign-language gesture as the user performs sign language, or the gesture when the user holds the auxiliary object.

The database records a plurality of reference images and control commands, in which each reference image may correspond to at least one control command. Further, a computing unit is included to connect with the image processing unit and the database, and used for comparing the reference image stored in the database with the gesture recognized by the image processing unit. Therefore the control command corresponding to the reference image matched up with the recognized gesture may be obtained.

The claimed control system is configured to operate an electronic device responsive to the control command in connection with the recognized gesture.

### BRIEF DESCRIPTION OF THE DRAWINGS

FIG. 1 is a block diagram illustrating the control system of one of the embodiments in accordance with the present invention;

FIG. 2 shows a schematic diagram of the control system in one embodiment of the present invention;

FIGS. 3A-3D schematically show various gestures in one embodiment of the present invention;

FIGS. 4A-4D schematically show various gestures in one embodiment of the present invention;

FIGS. 5A-5C schematically describe the sign-language gestures in one embodiment of the present invention;

FIG. 6 schematically shows a hand gripping an auxiliary object in one embodiment of the present invention;

FIGS. 7A-7C is an embodiment illustrating a sign-language gesture combined with an auxiliary object in accordance with the present invention.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

Embodiment of the Control System with Gesture-Based Input Method:

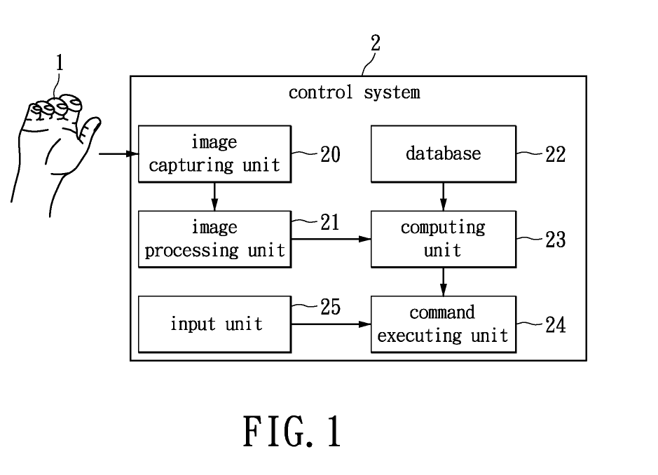

Reference is made to FIG. 1 showing a block diagram which illustrates a control system with gesture-based input method of the present invention. The shown control system 2 includes an image capturing unit 20, an image processing unit 21, a database 22, a computing unit 23 and a command executing unit 24. The image capturing unit 20 is coupled to the image processing unit 21. The image processing unit 21, database 22 and command executing unit 24 are separately connected to the computing unit 23.

In which, the image capturing unit 20 may be a video camera or still camera using the light sensor such as CCD or CMOS. The image capturing unit 20 is used to capture an input image of a user 1. The input image includes the user 1's gesture, such as the gesture made by the user 1's hand, arm, or in combination of the hand and arm. In detail, the gesture of hand may be made by palm, finger(s) or their combination. More specifically, the gesture may be made by the sign language for human's communication, such as the gesture made by the user 1's single hand, both hands, or in combination of the hands and arms. The user 1's hand gripping an auxiliary object may also shape the gesture.

After the image capturing unit 20 captures the input image with the gesture. The input image is transferred to the image processing unit 21. An image processing algorithm is then executed to perform the image analysis and processing for recognizing the gesture in the input image for the further comparison. The mentioned image processing algorithm for recognizing the gesture in the input method is such as a method for extracting and analyzing image characteristics, a method of background subtraction, or an Adaboost algorithm.

The database 22 records a plurality of reference images. Each reference image corresponds to at least one control command. Every reference image is specified to a gesture. The gesture is such as a sign-language gesture or gesture of a hand gripping an auxiliary object. The control command may denote a command of capturing the user 1's image, turning on display of an electronic device, closing display of the electronic device, locking up picture on the display, unlocking the picture on the display, shutting down the electronic device, initiating the electronic device, deactivating a specific function of the electronic device, or activating the specific function of the electronic device. Further control command is also such as paging up, paging down, entering canceling, zooming in, zooming out, flipping, rotating, playing video or music, opening program, closing program, sleeping, encrypting, decrypting, data computation or comparison, data transmitting, displaying data or image, or performing image comparison. The above-mentioned control commands are merely the examples but not used to limit the items or types of the control commands configured or executed by the claimed control system 2.

While the computing unit 23 receives the gesture recognized by the image processing unit 21, the recognized gesture is compared with the reference images in the database 22 for determining if there is any reference image in the database 22 matched up with the recognized gesture. If it is determined that a reference image is matched up with the gesture, a control command corresponding to the reference image can be read.

Next, the command executing unit 24 will receive the control command read by the computing unit 23, and responsive to the control command an electronic device (not shown in FIG. 1) can be operated to execute the control command. For example, the control command is executed to operate the electronic device to turn on its display for displaying picture. The electronic device may be a device capable of data processing implemented as a desktop computer, notebook computer, tablet, smart phone, personal digital assistant, or television. This electronic device may also be integrated with a wheelchair or a vehicle.

In which, the control system 2 is installed into the electronic device. The image capturing unit 20 may be built in or externally installed with the electronic device. In an exemplary example, a central processor, an embedded processor, a micro-controller, or a digital signal processor is the major processor of the electronic device. The processes made by the image processing unit 21, the computing unit 23, and the command executing unit 24 may be integrated into the major processor of the electronic device. Alternatively, the image processing unit 21, the computing unit 23, and the command executing unit 24 may also be embodied by the proprietary processing chip. The database 22 may be in the non-volatile storage of the electronic device. The storage can be hard disk, flash memory, or EEPROM.

Furthermore, the control system 2 in accordance with the present invention also includes an input unit 25 for receiving the user 1's input command rather than the performing his gesture. This input unit 25 may be the tangible input device such as computer mouse, keyboard, touch panel, handwriting tablet, or an audio input device, for example a microphone. The mentioned command executing unit 24 may further receive the input command from the input unit 25. After executing the control command, this input command may then be executed to operate the electronic device. In an exemplary example, a specific program of the electronic device may firstly be initiated by the user 1's gesture. The user 1 next uses the input unit 25 to generate input command to select an item of the program. It is noted that the input unit 25 may not the essential component to implement the control system 2 according to the present invention.

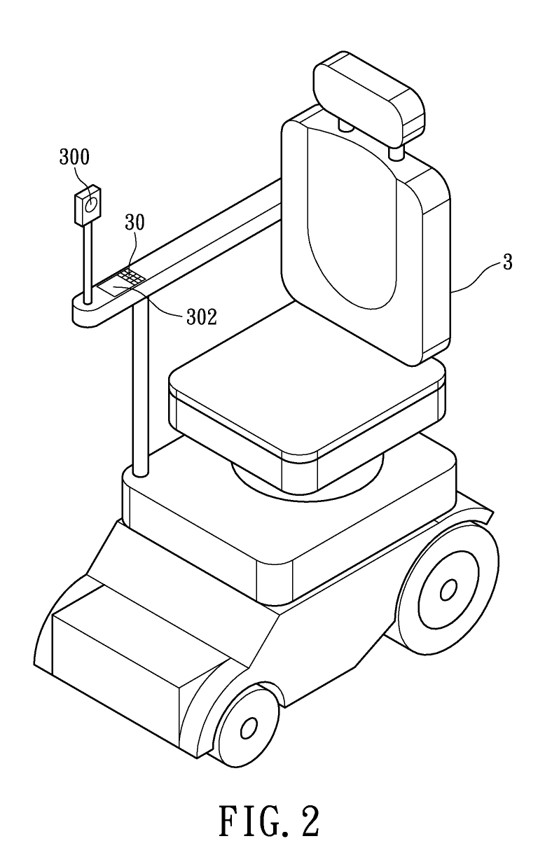

Reference is next made to FIG. 2, which illustrates a schematic diagram of the embodiment of the control system with gesture-based input method. The system shown in FIG. 2 may be in view of the block diagram described in FIG. 1.

In one of the exemplary embodiments, the control system 2 may be adapted to the electronic device 30, for example the tablet computer, combined with a wheelchair 3. In this example, the image capturing unit 20 of the system 2 may be a capture lens 300 installed on an armrest. When any user sits in the chair and faces the capture lens 300, the capture lens 300 is configured to capture the user's gesture and generate an input image. The input image is then delivered to a CPU (not shown in FIG. 2) of a computer. The computer then conducts an image processing. Simultaneously, the computer reads out the reference images in the database (not shown in FIG. 2) for comparing with the captured image. The comparison may result in acquiring a control command, which is used to perform a corresponding operation for controlling the computer or even the operation of the wheelchair 3 according to the current example.

Further, rather than the above description in which the capture lens 300 is used to capture the user's gesture for conducting operation, the input unit 25 mounted onto the electronic device 30 may also be used. For example, a touch pad 302 shown in FIG. 2 may be used to conduct the complex operations.

The following statements specifically illustrate the various types of the gestures. The gestures include hand gestures including those of palms and fingers, and arm gestures.

The hand gestures mean a left-handed gesture or a right-handed gesture, and the gesture of combined left and right hands. More specifically, the hand gesture may be exemplarily the gesture of fisting left hand, outstretching single finger (left hand), outstretching two fingers of left hand, outstretching three fingers of left hand, outstretching four fingers of left hand, opening palm of left hand, fisting right hand, outstretching single finger of right hand, outstretching two fingers of right hand, outstretching three fingers of right hand, outstretching four fingers of right hand, or opening palm of the right hand.

On the other hand, the arm gesture means the left-arm gesture, right-arm gesture, or the gesture of combined left and right arms.

The gesture adapted to the control system may also include gesture of left hand, right hand, and combination of left and right hands. The single motion or cyclic motions may form the hand gesture.

In an exemplar example of the left-handed gesture, the hand gesture may be the single motion or cyclic motions of any left hand. The gesture may also be formed by single motion or cyclic motions of combination of various gestures of the left hand.

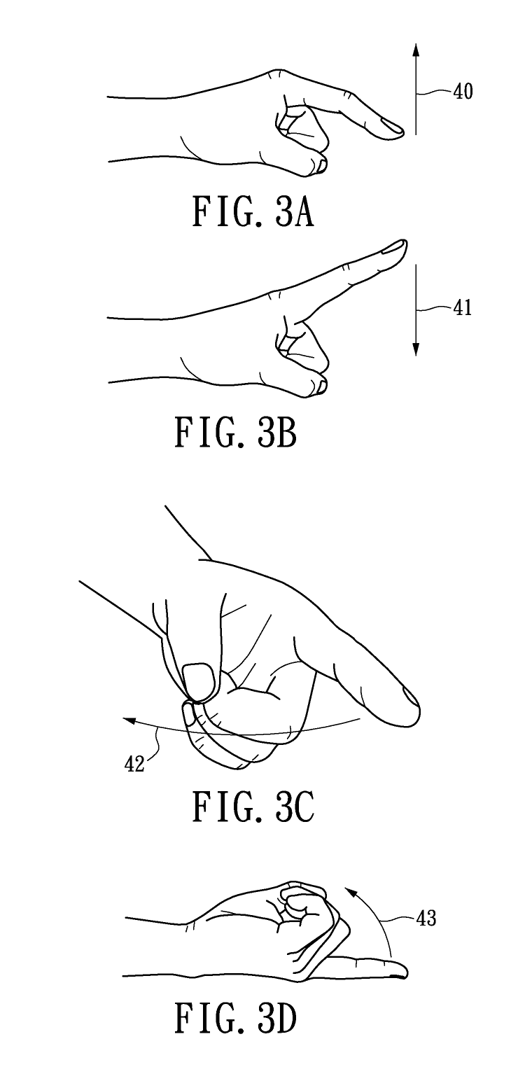

Example is referred to the left-handed gesture shown in FIG. 3A. The gesture is such as the individual motion (the direction 40) of waving up the outstretched single finger of left hand. Similar with the diagram of FIG. 3B, the gesture is such as the individual motion (direction 41) of waving down the outstretched single finger of the left hand. FIG. 3C shows an individual motion 42 of waving a sideward “checkmark” of the outstretched single finger of left hand. FIG. 3D further shows an individual motion of waving an inward “checkmark” of the outstretched single finger of the left hand, such as the shown direction 43.

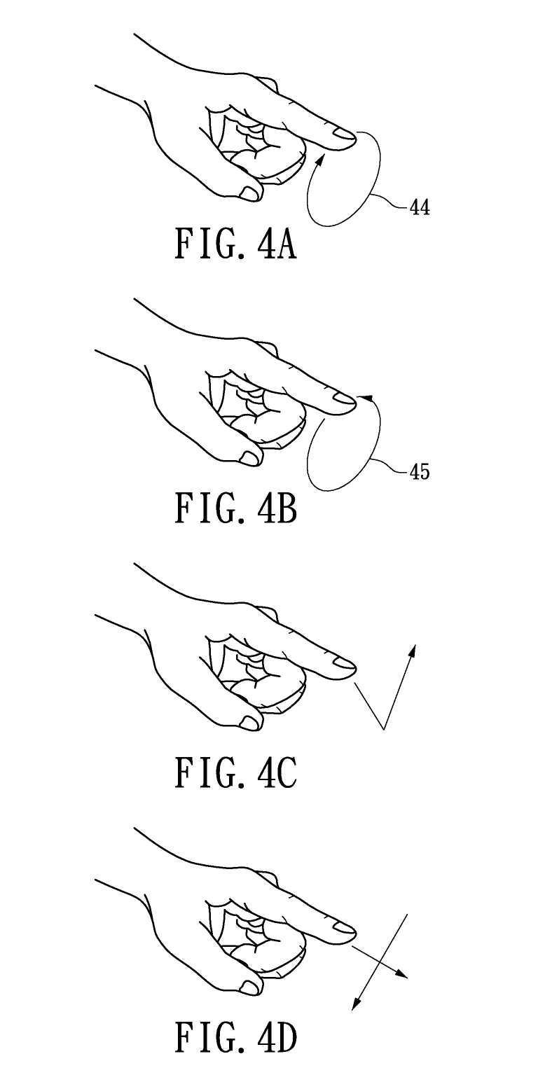

In addition, the left-handed gesture may also be the various gestures schematically shown in FIGS. 4A through 4D. FIG. 4A shows the gesture of a clockwise movement 44 of a single finger of left hand. FIG. 4B shows the gesture of a counterclockwise movement 45 of the single finger of left hand. FIG. 4C shows the “checkmark” motion of the left hand's single finger. FIG. 4D shows the gesture of a cross motion of the single finger of left hand.

FIGS. 3A through 3D and FIGS. 4A through 4D show the examples of the variances of the single finger of left-handed gestures. However, the left-handed gestures may not be limited to the above-described types. The gestures are such as motion of clicking, filliping of touching thumb and middle finger, or clapping. The descriptions related to the left-hand gestures are also applied to the right-handed gestures.

The gestures may not merely the gestures of hands or/and arms, but also any combination of hands and arms. For example, the combination may be fisting two hands, the praying hands, crossing fingers of two hands, outstretching two arms, and in combination of these gestures.

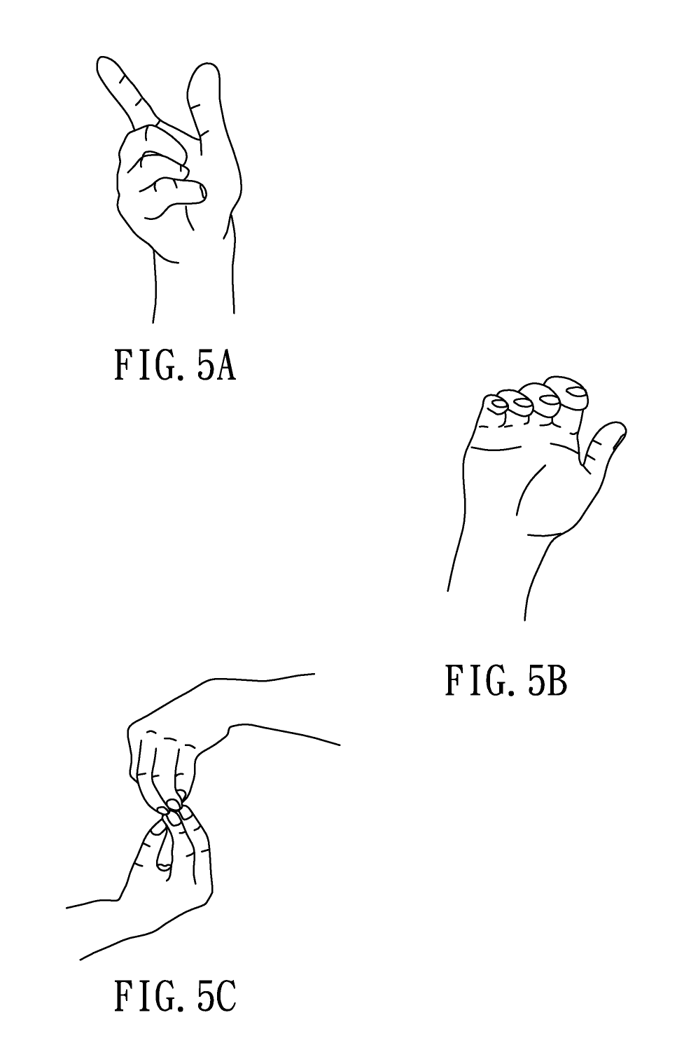

In accordance with the present invention, by means of the various combinations of gestures of hands and/or arms, the meanings of number, quantity, English letters, finish, “OK”, time out, crash, dead, walk, come or go can be denoted for inputs of the control system 2. Based on the recognition conducted by the image processing unit 21 of the control system 2 and the comparison made by the computing unit 23, a control command corresponding to the gesture can be acquired. The command executing unit 24 the executes the control command for configuring the electronic device, particularly based on the user's gestures. In one exemplary example, sign language may be a classical gesture to conduct the configuration, such as combining the user 1's fingers, palms, or/and arms. FIGS. 5A through 5C separately describe the sign-language gestures.

The sign language usually requires combinations of the user 1's fingers, palms, or/and arms. In which, the gestures may be collocated with the joints with specified angles for generating more complex or continuous changes of the gestures. The many gestures may relate to various meanings which are to be inputs for operating the electronic device. The image processing unit and computing unit make more precision and accurate operations.

Another Embodiment of the Control System with Gesture-Based Input Method:

The input image captured by the image capturing unit 20 may further include an auxiliary object held by the user 1's hand. The auxiliary object is such as, but not limited to, a pen, ruler, lipstick or paper. The reference images stored in the database 22 may include the images of gestures holding the similar or identical auxiliary objects. The reference images are for the comparison conducted by the computing unit 23.

While the image processing unit 21 performs analysis and recognition onto the input image, the auxiliary object held by the user 1's hand can be recognized rather than recognizing the gestures, for example the sign-language gesture. The image features of recognized gestures and the auxiliary object are then delivered to the computing unit 23. The computing unit 23 reads out the reference images of the database 22 for comparing with the image features. The related reference image(s) matched up with the features may be obtained based on the comparison. After that, the control command corresponding to the matched reference image is acquired.

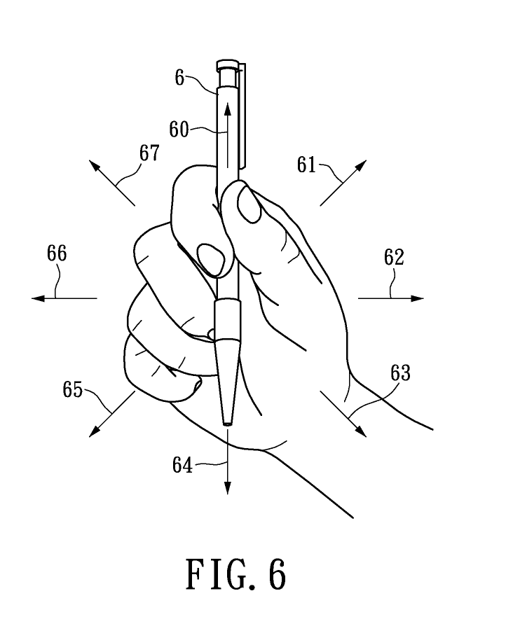

Reference is made to FIG. 6 illustrating the diagram of gestures with the auxiliary object 6.

The auxiliary object 6, for example, may be gripped by the user's hand. In FIG. 6, a gesture of a fisting right hand gripping the auxiliary object 6 is shown. The image processing unit 21 in this example recognizes the user 1's fisting hand, and the direction of the auxiliary object 6 when the object 6 is gripped. The direction can be any of the shown direction 60 to the direction 67. The gesture with the auxiliary object 6 specified to a direction is provided for the computing unit 23 to compare with the reference images.

The diagram shown in FIG. 6 may merely an example to describe the invention. The input image with the shown auxiliary object 6 is not limited to the above figures and descriptions. The more examples are such as the input image showing any two fingers of the user's hand clipping the auxiliary object 6, and the auxiliary object 6 pointing to any direction of the direction 60 to direction 67.

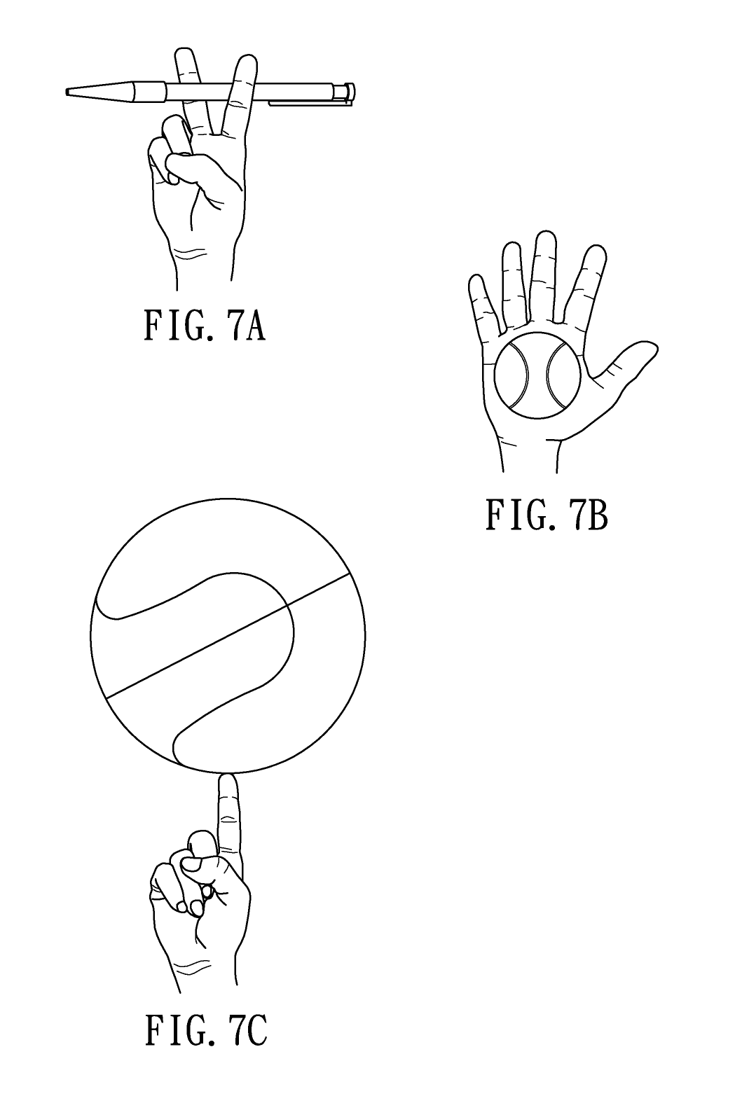

FIG. 7A shows the gesture of a pen clipped by an index finger and a middle finger. The input image includes combination of any previous hand gesture or arm gesture, and the auxiliary object. The combination may collocate to various inputs. For example, the combination of sign-language gesture and the hand-held auxiliary object 6 may relate to an input.

FIG. 7B shows a globular auxiliary object 6 placed in center of a user's palm. FIG. 7C shows the auxiliary object 6 placed at a fingertip, and the other fingers in different gesture. This sign-language gesture with the fingertip combined with the gesture of other fingers may denote a specific input.

One Embodiment of the Control System:

The input image in accordance with the present embodiment may include face posture besides the user 1's gesture. The gesture includes the user 1's face posture. Therefore, the image processing unit 21 recognizes the face posture according to the distances among the user 1's eyebrows, eyes, nose, teeth, or/and mouth, rather than his gesture. The reference images in the database 22 are the images with the face postures, gestures, and their combinations for the computing unit 23 to conduct comparison.

The face postures may describe the user 1's emotions including happy, angry, sad, fear, evil, crying, good, bad, despised, cursed, frightened, and confused. The face posture may also be the user 1's opening two eyes, closing single eye, closing two eyes, opening mouth, closing mouth, protruding lips while the lips is making rounded “o” shape, opening mouth and extending tongue, or smile with exposing teeth.

The face posture shows the user 1's facial expression or changes of emotions. That is, the single motion or cyclic motions of the face posture, or their combination may form the gesture as an input of the control system. The combination may be the single or cyclic motions of blinking single eye, alternately blinking two eyes, simultaneously blinking two eyes, opening mouth, or extending or contracting tongue. The variations of the mouth when the user performs lip language are classical postures of face.

The gesture or face posture are recognized by the image processing unit 21, and their combination is delivered to the computing unit 23 for conducting comparison. When there is any reference image in the database 22 matched up with the image with the gesture and the face posture, the computing unit 23 is allowed to select a control command corresponding to the matched reference image. The electronic device is accordingly operated based on the gesture-based input method.

The redundant description between the current embodiment and the previous embodiments may not be provided. The related descriptions may be referred to the previous statements.

Possible Effects of the Embodiments:

In accordance with one of the embodiments of the present invention, the control system adopts the user's gestures to be an input for operating the electronic device. To compare with the other tangible input devices, the present invention provides an input method with features of more intuitive and easy to understand because the user has excellent capability of controlling and coordinating his own gestures. The invention effectively eliminates the difficulties of learning the traditional input devices.

Furthermore, the input method using the user's gestures can save the space occupied by the tangible input devices. The user may avoid the injure resulting in clicking the computer mouse or striking the keyboard for a long time.

Furthermore, in accordance with the embodiments of the present invention, besides the gesture-based input method adapted to the control system, the other recognizable user's body languages such as gestures of legs, feet, and face are also included. Further, more variations of the gestures may be the mentioned body languages collocated with the user's hand gestures. Provisions are made to have various types of the input methods of the control system, and are advantageous to issue control commands to the electronic device more precisely. The electronic device is operated well according to the user's body gestures.

It is worth noting that, the control system of the present invention may also involve the input methods such as lip language, or/and sign language. Even through the user may be under a circumstance of unable to typewrite, or perform voice input, for example the disabled person, or in outer space, the facial expressions or gestures can also be the inputs for configuring the electronic device.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A control system with a gesture-based input method, comprising:
an image capturing unit, for retrieving an input image including a gesture of a user, which includes a gesture by performing sign language, or another gesture with an auxiliary object held by the user's hand;
an image processing unit, connected with the image capturing unit, for receiving and recognizing the gesture in the input image;
a database, recording a plurality of reference images and corresponding control commands, in which each reference image corresponds to at least one control command;
a computing unit, connected with the image processing unit and the database, comparing the reference images in the database with the gesture recognized by the image processing unit for acquiring the control command corresponding to the reference image matched up with the gesture;
wherein, the control command acquired by the control system responsive to the gesture is used to control an electronic device.

2. The control system according to claim 1, further comprising:
a command executing unit, connected with the computing unit, for receiving the control command resulted in comparison performed by the computing unit, and executing the control command to operate the electronic device.

3. The control system according to claim 1, further comprising:
an input unit, connected with the command executing unit, for generating an input command as receiving the user's input;
wherein, the command executing unit controls the electronic device according to the control command and the input command, and the input unit is a touch panel, a keyboard, a computer mouse, a handwriting tablet, or an audio input device.

4. The control system according to claim 1, wherein the control command is specified to page up, page down, enter, quit, cancel, zoom in, zoom out, flip, rotate, capture the user's image, initiate a display of the electronic device, shutdown the display, lock up a picture on the display, unlock the picture on the display, shutdown the electronic device, initiate the electronic device, activate a function of the electronic device, deactivate the electronic device, play multimedia, open program, close program or enter a sleeping.

5. The control system according to claim 2, wherein the control command is specified to page up, page down, enter, quit, cancel, zoom in, zoom out, flip, rotate, capture the user's image, initiate a display of the electronic device, shutdown the display, lock up a picture on the display, unlock the picture on the display, shutdown the electronic device, initiate the electronic device, activate a function of the electronic device, deactivate the electronic device, play multimedia, open program, close program or enter a sleeping.

6. The control system according to claim 3, wherein the control command is specified to page up, page down, enter, quit, cancel, zoom in, zoom out, flip, rotate, capture the user's image, initiate a display of the electronic device, shutdown the display, lock up a picture on the display, unlock the picture on the display, shutdown the electronic device, initiate the electronic device, activate a function of the electronic device, deactivate the electronic device, play multimedia, open program, close program or enter a sleeping.

7. The control system according to claim 1, wherein the gesture is gesture of hands, gesture of arms, or combination of the hands and the arms.

8. The control system according to claim 1, wherein the gesture is outstretching single finger, outstretching multiple fingers, or fisting a hand.

9. The control system according to claim 1, wherein the gesture is fisting two hands, praying hands, crossing fingers, outstretching one arm, or outstretching both arms.

10. The control system according to claim 1, wherein the gesture means clockwise movement of hand, counter-clockwise movement of hand, outside to inside movement of hand, inside to outside movement of hand, movement of clicking, crossing, checking, or flapping.

11. The control system according to claim 1, wherein gesture denotes number, quantity, English letter, finish, OK, suspend, crash, dead, walk, come or go.

12. The control system according to claim 1, wherein the input image further includes the user's face posture, and the image processing unit recognizes the face posture of the input image, the reference images in the database include image of combining the gesture and the face posture, the computing unit further receives image of the face posture recognized by image processing unit, and the reference images are used to compare with the image of the face posture for acquiring the control command corresponding to the reference image matched up with the image of combining the gesture and the face posture.

13. The control system according to claim 12, wherein the face posture is related to a facial expression or emotion of happy, angry, sad, joy, fear, evil, cry, good, bad, disdain, curse, frightened, or confuse.

14. The control system according to claim 12, wherein the image processing unit recognizes the face posture according to distances among the user's eyebrows, eyes, nose and/or mouth.

15. The control system according to claim 12, wherein the face posture is the user's opening eyes, closing one eye, closing eyes, opening mouth, closing mouth, protruding lips, opening mouth with extending tongue, or closing mouth with extending tongue.

16. The control system according to claim 12, wherein the face posture is the gesture generated while the user performs lip language or speaks.

17. The control system according to claim 12, wherein the face postures include blinking single eye, alternate blinking two eyes, simultaneous blinking two eyes, opening or closing mouth, or extending or contracting tongue.
